(19) United States
(12) Patent Application Publication
(10) Pub. No.: US 2026/0005588 A1
(43) Pub. Date: Jan. 1, 2026

(54) INDUCTION MOTOR INCLUDING REINFORCED END RINGS

(71) Applicant: GM GLOBAL TECHNOLOGY OPERATIONS LLC, Detroit, MI (US)

(72) Inventors: Qigui WANG, Rochester Hills, MI (US); John S. Agapiou, Rochester Hills, MI (US); Tyson Whittier Brown, Royal Oak, MI (US); Devin R. Hess, Clarkston, MI (US)

(21) Appl. No.: 18/756,770

(22) Filed: Jun. 27, 2024

(51) Int. Cl. H02K 17/20

(52) U.S. Cl. CPC H02K 17/20

(57) ABSTRACT

An electric machine including a stator and a rotor. The rotor is configured to rotate within the stator and includes: a core; a first end ring at a first end of the core and a second end ring at a second end of the core; conductors extending across the core that electrically connect the first end ring and the second end ring; and a first reinforcing ring that is cast within the first end ring and a second reinforcing ring that is cast within the second end ring.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to an induction motor including reinforced end rings.

An induction motor, also known as an asynchronous motor, is an electric machine that operates based on electromagnetic induction. The motor includes a stator winding that generates a rotating magnetic field. This magnetic field induces a current in a rotor due to electromagnetic induction. As a result, the rotor rotates, which produces mechanical output. An induction motor is a versatile and efficient type of electric machine that converts electrical energy into mechanical energy through electromagnetic induction. Induction motors are used in various automotive and non-automotive applications.

### SUMMARY

The present disclosure includes, in various features, an electric machine including a stator and a rotor. The rotor is configured to rotate within the stator and includes: a core; a first end ring at a first end of the core and a second end ring at a second end of the core; conductors extending across the core that electrically connect the first end ring and the second end ring; and a first reinforcing ring that is cast within the first end ring and a second reinforcing ring that is cast within the second end ring.

In further features, the electric machine is an induction motor.

In further features, the core, the first end ring, and the second end ring are formed by die casting.

In further features, the core includes a plurality of steel laminations defining slots extending across the core to the first end ring and the second end ring, the conductors are within the slots.

In further features, the conductors include aluminum cast within the slots.

In further features, the conductors include bars extending through the slots.

In further features, the bars include copper.

In further features, the first reinforcing ring defines first slots and the second reinforcing ring defines second slots, first bar ends of the bars are seated within the first slots and second bar ends of the bars are seated within the second slots.

In further features, the first end ring and the second end ring are both cast aluminum.

In further features, the first reinforcing ring and the second reinforcing ring are made of ceramic.

In further features, the first reinforcing ring and the second reinforcing ring are made of a conductive material.

In further features, the first reinforcing ring and the second reinforcing ring are porous.

In further features, at least one of the first reinforcing ring and the second reinforcing ring include locator pins protruding from an outer surface.

The present disclosure also provides for, in various features, a stator and a rotor configured to rotate within the stator. The rotor includes: a core including a plurality of steel laminations defining slots extending across the core; a first end ring at a first end of the core and a second end ring at a second end of the core, the first end ring and the second end ring formed by die casting; conductors within the slots defined by the plurality of steel laminations, the conductors extending across the core to electrically connect the first end ring and the second end ring; and a first reinforcing ring that is cast within the first end ring, and a second reinforcing ring that is cast within the second end ring. The electric machine is configured as an induction motor.

In further features, the first end ring and the second end ring are formed from cast aluminum.

In further features, the conductors include aluminum cast within the slots or copper bars.

In further features, both the first reinforcing ring and the second reinforcing ring include locator pins protruding from an outer surface.

The present disclosure further provides for, in various features, an electric machine including a stator and a rotor configured to rotate within the stator. The rotor includes: a core including a plurality of steel laminations defining slots extending across the core; a first end ring at a first end of the core and a second end ring at a second end of the core, the first end ring and the second end ring formed by die casting; conductors within the slots defined by the plurality of steel laminations, the conductors extending across the core to electrically connect the first end ring and the second end ring, the conductors include one of cast aluminum and metallic bars; and a first reinforcing ring that is cast within the first end ring, and a second reinforcing ring that is cast within the second end ring, both the first end ring and the second end ring are annular rings and include locator pins protruding from an outer surface, the locator pins configured to position the first reinforcing ring and the second reinforcing ring within a mold. The electric machine is configured as an induction motor.

In further features, the first reinforcing ring and the second reinforcing ring are ceramic.

In further features, the first reinforcing ring and the second reinforcing ring are made of carbon nanotubes or graphene.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross-sectional view of an electric machine in accordance with the present disclosure;

FIG. 2 is a cross-sectional view of a mold for forming a rotor of the electric machine by casting;

FIG. 3A is a perspective view of a reinforcing ring in accordance with the present disclosure for an end ring of the electric machine;

FIG. 3B is a plan view of the reinforcing ring of FIG. 3A;

FIG. 3C is a cross-sectional view of the reinforcing ring of FIG. 3A;

FIG. 4A is a perspective view of another reinforcing ring in accordance with the present disclosure for an end ring of the electric machine;

FIG. 4B is a plan view of the reinforcing ring of FIG. 4A;

FIG. 4C is a cross-sectional view of the reinforcing ring of FIG. 4C;

FIG. 5 is a perspective view of an additional reinforcing ring in accordance with the present disclosure for an end ring of the electric machine;

FIG. 6 is a cross-sectional view of an electric machine in accordance with the present disclosure including solid conductive bars extending through a rotor core thereof;

FIG. 7 is a plan view of a reinforcing ring in accordance with the present disclosure for an end ring of the electric machine of FIG. 6; and

FIG. 8 is a cross-sectional view of the reinforcing ring of FIG. 7.

In the drawings, reference numbers may be reused to identify similar and/or identical elements.

### DETAILED DESCRIPTION

An induction motor includes a die-cast rotor configured to rotate inside of a stator. The rotor includes multiple metallic laminations that are stacked together and define slots extending across a core of the rotor. End rings are at opposite ends of the slots. The slots are filled with conductors to create a cage configuration. Such cage-induction machines have widespread use in industrial applications, such as automotive and non-automotive applications. The present disclosure provides for reinforcing rings within the end rings to facilitate performance at high motor speeds. The reinforcing rings support tensile stresses of the end rings at high rotational speeds and sustain a hoop stress in the end rings.

The end rings are attached at opposite ends of the rotor core. The reinforcing rings are attached in a preheated condition inside of a die cavity of the end rings. Locating features may be used on the reinforcing rings to control location of the reinforcing rings in the cavity. This allows the reinforcing rings to be over-cast by the end ring material. The reinforcing rings may have porosity or specific features around their perimeter on the inside and/or outside surface to interlock with the end rings mechanically and metallurgically. The preheated temperature of the reinforcing rings is based on the material of the reinforcing rings to provide good mechanical interlock and metallurgical bonds with the end rings. The reinforcing rings allow for higher stresses on the end rings at maximum intended rotational speed of the rotor.

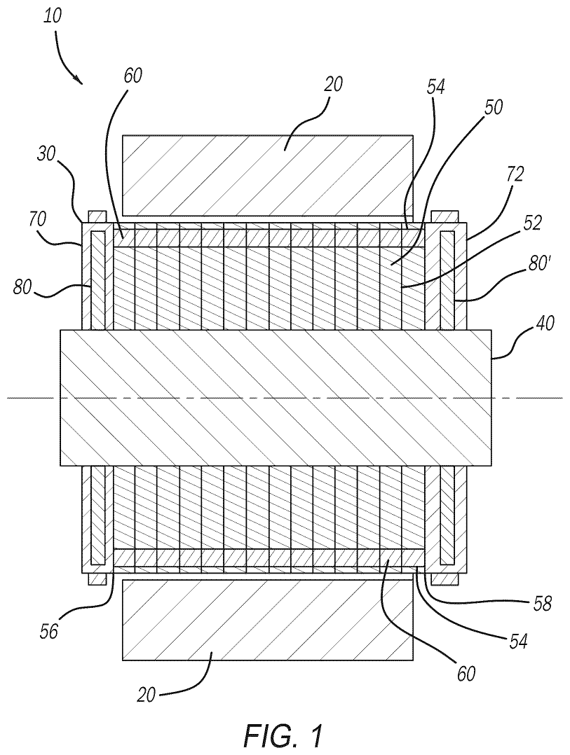

FIG. 1 illustrates an exemplary electric machine 10 in accordance with the present disclosure. The electric machine 10 may be an induction motor, or any other suitable electric machine. The electric machine 10 may be configured for use in any suitable application, such as any suitable automotive and/or non-automotive application.

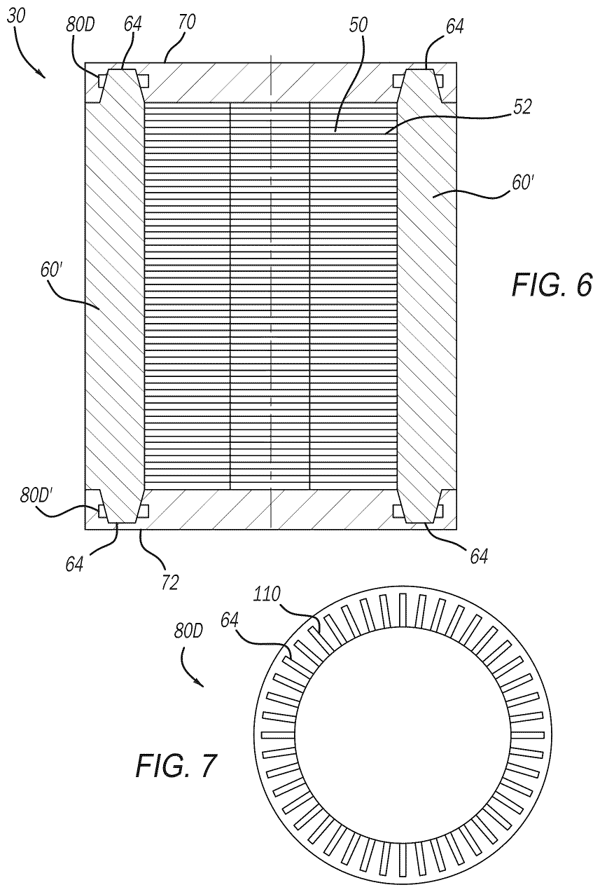

The electric machine 10 generally includes a stator 20 and a rotor 30 rotatably mounted within the stator 20. The rotor 30 is mounted to a shaft 40. The rotor 30 includes a core 50. The core 50 includes a stack of a plurality of laminated plates 52. The laminated plates are made of any suitable conductive material, such as steel or any other suitable metallic material. The laminated plates 52 define slots 54. The slots 54 extend from a first end 56 of the core 50 to a second end 58 of the core 50. Within the slots 54 are any suitable conductors 60. The conductors 60 may be, for example, aluminum cast within the slots 54. With reference to FIG. 6, for example, conductors 60′ may be included, which take the form of solid bars, such as copper bars.

At the first end 56 of the core 50 is a first end ring 70. At a second end 58 of the core 50 is a second end ring 72. The first end ring 70 and the second end ring 72 are made of any suitable conductive material and are electrically connected to the conductors 60. The first end ring 70 and the second end ring 72 provide a short-circuit path between the conductors 60. The first end ring 70 and the second end ring 72 may be cast from aluminum, for example.

Within the first end ring 70 is a first reinforcing ring 80, and within the second end ring 72 is a second reinforcing ring 80′. The first reinforcing ring 80 and the second reinforcing ring 80′ are the same or substantially similar. Thus, the following discussion of the first reinforcing ring 80 (also referred to herein as “the reinforcing ring” to facilitate discussion), and the variations thereof contemplated by the present disclosure, also applies to the second reinforcing ring 80′.

The reinforcing ring 80 may be made of any suitable material, and formed in any suitable manner. For example, the rotor 30 may be a cast aluminum rotor, and the reinforcing ring 80 may be made of any suitable ceramic or other highly conductive material. The reinforcing ring 80 is cast within the first end ring 70 (or the second end ring 72) to provide a metal-matrix composite (MMC) structure. The reinforcing ring 80 may be made by high pressure die casting, low pressure die casting, or squeeze casting, for example. When made of a ceramic material, the reinforcing ring 80 may be made of, for example, ceramic fibers, whiskers, or powders such as silicon carbide (SIC), alumina (aluminum oxide, Al₂O₃), etc. The reinforcing ring 80 may also be made of, for example, carbon nanotubes, graphene, or any other suitable highly conductive material. Regardless of the specific material used, the reinforcing ring 80 may be fabricated using an additive manufacturing process. The reinforcing ring 80 may be made from a slurry and polyvinyl alcohol (PVA) solution, and then dried. Prior to casting, the reinforcing ring 80 is pre-heated.

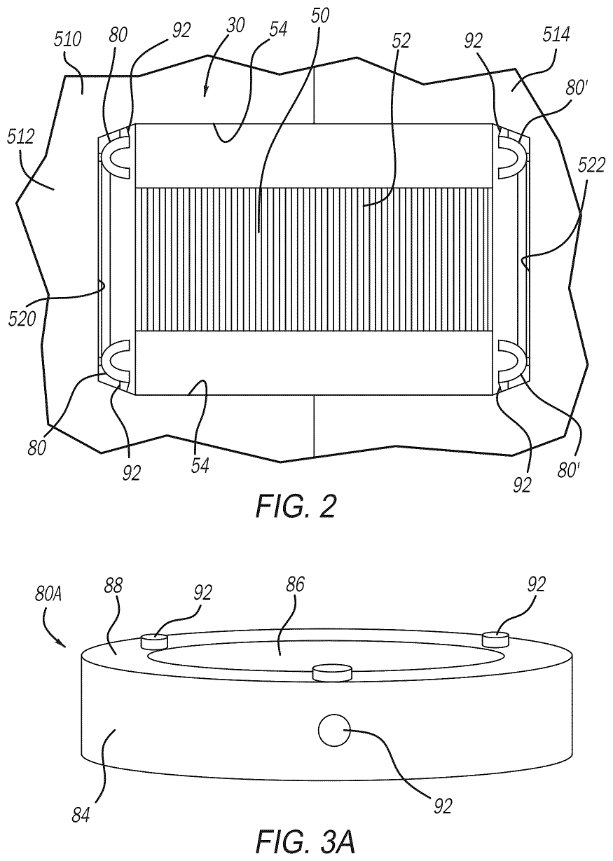

FIG. 2 illustrates an exemplary mold 510 for forming the rotor 30 by casting. The mold 510 includes a first mold half 512 and a second mold half 514. The first mold half 512 defines a first receptacle 520 and the second mold half 514 defines a second receptacle 522. The first reinforcing ring 80 is seated at a base of the first receptacle 520. The second reinforcing ring 80′ is seated at a base of the second receptacle 522. A stack of the laminated plates 52 are arranged on an arbor, which holds the laminated plates 52 together. The first mold half 512 and the second mold half 514 are closed and then the rotor 30 is cast. Specifically, aluminum or any other suitable conductive material is injected into the first receptacle 520 to form the first end ring 70 over the first reinforcing ring 80, and is injected into the second receptacle 522 to form the second end ring 72 over the second reinforcing ring 80′. To facilitate centering the first reinforcing ring 80 and the second reinforcing ring 80′ in the first mold half 512 and the second mold half 514 respectively, both the first reinforcing ring 80 and the second reinforcing ring 80′ include locator pins 92, which are described further herein. The locator pins 92 contact surfaces of the first receptacle 520 and the second receptacle 522 to arrange the first reinforcing ring 80 and the second reinforcing ring 80′ at an intended predetermined position. The locator pins 92 may be provided with an extended length to cooperate with receptacles of the mold 510 (see locator pins 92′ of FIG. 5).

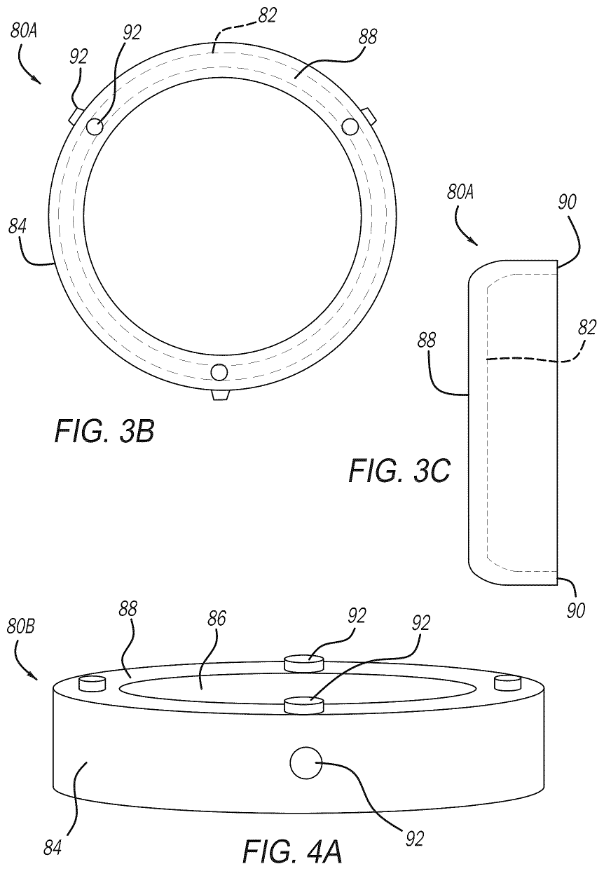

FIGS. 3A, 3B, and 3C illustrate another exemplary reinforcing ring 80A in accordance with the present disclosure. The reinforcing ring 80A is configured to be arranged within the first end ring 70 and/or the second end ring 72 in the same manner as described with respect to the reinforcing ring 80, and as illustrated in FIGS. 1, 2, and 6, for example. The reinforcing ring 80A may be made of the same materials described with respect to the reinforcing ring 80, and formed in the same manner. The reinforcing ring 80A includes an outer surface 88 and an inner surface 82, which is generally opposite to the outer surface 88. The inner surface 82 defines a channel or pocket within the reinforcing ring 80A (illustrated in phantom in FIGS. 3B and 3C). The reinforcing ring 80A is generally an annular ring, which includes a side surface 84 and interior surface 86 opposite to the side surface 84. The interior surface 86 defines an opening at a center of the annular ring. An annular flange 90 extends about an outer periphery of the inner surface 82. The reinforcing ring 80A (as well as any of the other reinforcing rings of the present disclosure) may have any other suitable shape as well, such as, but not limited to, an L-shape, a half-circle shape, etc.

The reinforcing ring 80A includes a plurality of the locator pins 92. The locator pins 92 protrude from any suitable surfaces of the reinforcing ring 80A. With respect to the example illustrated, the locator pins 92 protrude from the outer surface 88 and the side surface 84. The locator pins 92 abut inner surfaces of the receptacle 520 and the second receptacle 522 of the mold 510 to center the reinforcing ring 80A within the mold 510.

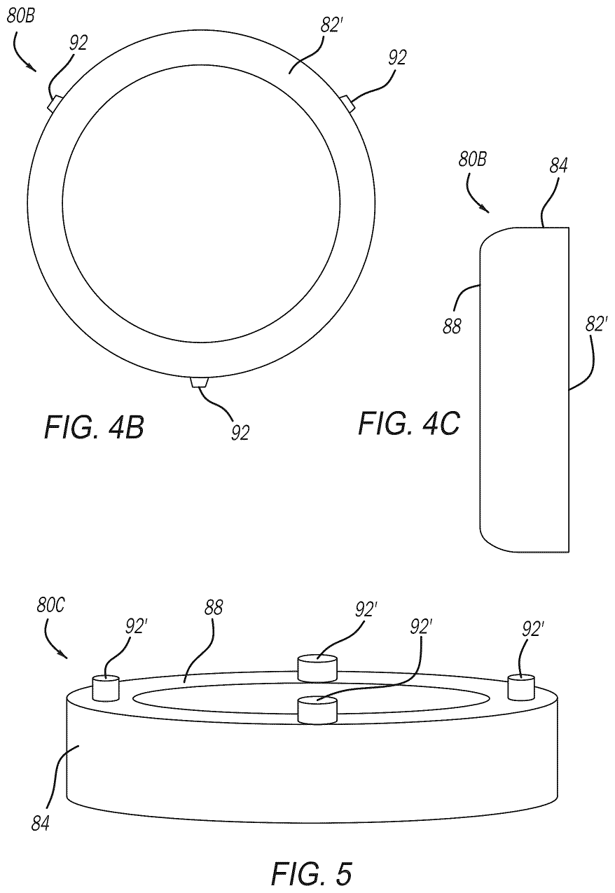

FIGS. 4A, 4B, and 4C illustrate an additional example of a reinforcing ring 80B in accordance with the present disclosure. The reinforcing ring 80B is configured to be arranged within the first end ring 70 and/or the second end ring 72 in the same manner as described with respect to the reinforcing ring 80, and as illustrated in FIGS. 1, 2, and 6, for example. The reinforcing ring 80B may be made of the same materials described with respect to the reinforcing ring 80, and formed in the same manner. The reinforcing ring 80B, like the reinforcing ring 80A, is also annular shaped. Unlike the reinforcing ring 80A, however, the reinforcing ring 80B does not define an internal channel at the inner surface 82 (compare FIGS. 3C and 4C). Instead, the inner surface 82′ of the reinforcing ring 80B is a continuous flush surface. Otherwise, the description of the reinforcing ring 80A also applies to the reinforcing ring 80B. Both the reinforcing ring 80A and the reinforcing ring 80B (as well as any of the other reinforcing rings described herein) may have porous exterior surfaces or non-porous exterior surfaces.

FIG. 5 illustrates an additional reinforcing ring 80C in accordance with the present disclosure. The reinforcing ring 80C is configured to be arranged within the first end ring 70 and/or the second end ring 72 in the same manner as described with respect to the reinforcing ring 80, and as illustrated in FIGS. 1, 2, and 6, for example. The reinforcing ring 80C may be made of the same materials described with respect to the reinforcing ring 80, and formed in the same manner. The reinforcing ring 80C includes locator pins 92′, which are relatively taller than the locator pins 92 of the of the reinforcing rings 80A, 80B. The relatively taller locator pins 92′ are configured to be received within end ring dies for the first end ring 70 and the second end ring 72 to further secure the reinforcing ring 80C in position and work as a core print. The reinforcing ring 80C may be configured to include any of the features of one or more of the other reinforcing rings 80, 80A, 80B, and 80D.

FIG. 6 illustrates the rotor 30 configured with the conductor bars 60′ instead of the conductive aluminum (or other conductive material) added during casting. A plurality of the conductor bars 60′ are included, and they extend through each of the slots 54 in the laminated plates 52. Each conductor bar 60′ includes tips 64 at opposite ends thereof.

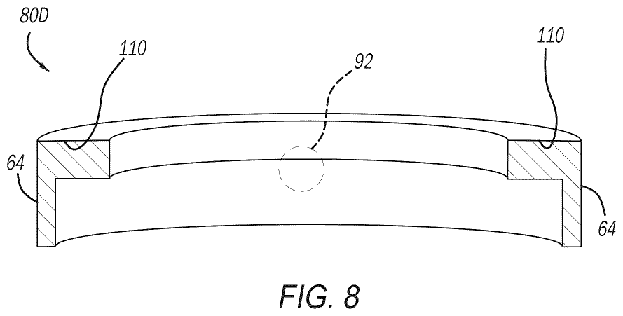

FIGS. 7 and 8 illustrate an exemplary reinforcing ring 80D, which defines a plurality of slots 110. The slots 110 of the reinforcing ring 80D are configured to receive the tips 64 of the conductor bars 60′. FIG. 6 illustrates the reinforcing ring 80D within the first end ring 70. Another reinforcing ring 80D′ is within the second end ring 72. The reinforcing ring 80D is made of the same materials as the reinforcing rings described above (such as the reinforcing ring 80), and may be made in the same manner.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. An electric machine comprising:
a stator; and
a rotor configured to rotate within the stator, the rotor including:
a core;
a first end ring at a first end of the core and a second end ring at a second end of the core;
conductors extending across the core that electrically connect the first end ring and the second end ring; and
a first reinforcing ring that is cast within the first end ring and a second reinforcing ring that is cast within the second end ring.

2. The electric machine of claim 1, wherein the electric machine is an induction motor.

3. The electric machine of claim 1, wherein the core, the first end ring, and the second end ring are formed by die casting.

4. The electric machine of claim 1, wherein the core includes a plurality of steel laminations defining slots extending across the core to the first end ring and the second end ring, the conductors are within the slots.

5. The electric machine of claim 4, wherein the conductors include aluminum cast within the slots.

6. The electric machine of claim 4, wherein the conductors include bars extending through the slots.

7. The electric machine of claim 6, wherein the bars include copper.

8. The electric machine of claim 6, wherein the first reinforcing ring defines first slots and the second reinforcing ring defines second slots, first bar ends of the bars are seated within the first slots and second bar ends of the bars are seated within the second slots.

9. The electric machine of claim 1, wherein the first end ring and the second end ring are both cast aluminum.

10. The electric machine of claim 1, wherein the first reinforcing ring and the second reinforcing ring are made of ceramic.

11. The electric machine of claim 1, wherein the first reinforcing ring and the second reinforcing ring are made of a conductive material.

12. The electric machine of claim 1, wherein the first reinforcing ring and the second reinforcing ring are porous.

13. The electric machine of claim 1, wherein at least one of the first reinforcing ring and the second reinforcing ring include locator pins protruding from an outer surface.

14. An electric machine comprising:
a stator; and
a rotor configured to rotate within the stator, the rotor including:
a core including a plurality of steel laminations defining slots extending across the core;
a first end ring at a first end of the core and a second end ring at a second end of the core, the first end ring and the second end ring formed by die casting;
conductors within the slots defined by the plurality of steel laminations, the conductors extending across the core to electrically connect the first end ring and the second end ring; and
a first reinforcing ring that is cast within the first end ring, and a second reinforcing ring that is cast within the second end ring,
wherein the electric machine is configured as an induction motor.

15. The electric machine of claim 14, wherein the first end ring and the second end ring are formed from cast aluminum.

16. The electric machine of claim 14, wherein the conductors include aluminum cast within the slots or copper bars.

17. The electric machine of claim 14, wherein both the first reinforcing ring and the second reinforcing ring include locator pins protruding from an outer surface.

18. An electric machine comprising:
a stator; and
a rotor configured to rotate within the stator, the rotor including:
a core including a plurality of steel laminations defining slots extending across the core;
a first end ring at a first end of the core and a second end ring at a second end of the core, the first end ring and the second end ring formed by die casting;
conductors within the slots defined by the plurality of steel laminations, the conductors extending across the core to electrically connect the first end ring and the second end ring, the conductors include one of cast aluminum and metallic bars; and
a first reinforcing ring that is cast within the first end ring, and a second reinforcing ring that is cast within the second end ring, both the first end ring and the second end ring are annular rings and include locator pins protruding from an outer surface, the locator pins configured to position the first reinforcing ring and the second reinforcing ring within a mold,
wherein the electric machine is configured as an induction motor.

19. The electric machine of claim 18, wherein the first reinforcing ring and the second reinforcing ring are ceramic.

20. The electric machine of claim 18, wherein the first reinforcing ring and the second reinforcing ring are made of carbon nanotubes or graphene.
